(19) United States
(12) Patent Application Publication
(10) Pub. No.: US 2022/0144180 A1
(43) Pub. Date: May 12, 2022

(54) RACK FOR STORAGE OF OUTDOOR POWER EQUIPMENT

(71) Applicant: Buyers Products Company, Mentor, OH (US)

(72) Inventor: Timothy Bunsey, Mentor, OH (US)

(73) Assignee: Buyers Products Company, Mentor, OH (US)

(21) Appl. No.: 17/198,959

(22) Filed: Mar. 11, 2021

Related U.S. Application Data
(60) Provisional application No. 63/110,550, filed on Nov. 6, 2020.

(51) Int. Cl. B60R 7/08; A01G 20/47

(52) U.S. Cl. CPC B60R 7/08; A01G 20/47

(57) ABSTRACT

Provided in this disclosure is a lockable equipment rack for a blower. The lockable equipment rack includes adjustable components configured to storage of a variety of blowers of different size and shape. The equipment rack can be installed in a variety of locations, for example, on an open trailer, to securely store a blower in areas that are easily accessible. The lockable equipment rack prevents theft of the blower and tampering of its components.

This application claims the benefit of U.S. Provisional Application No. 63/110,550, entitled LOCKABLE EQUIPMENT RACK, filed Nov. 6, 2020, which is fully incorporated herein by reference.

### I. BACKGROUND

### A. Technical Field

The present disclosure relates to equipment racks. More specifically, the present invention relates to a lockable equipment rack with adjustable components for storage of a variety of blowers.

### B. Background

There is a present need to securely store equipment such as a landscaping equipment on moveable trailers or storage units. The need requires a storage and security system that allows for easy access, ease of use and a system which is unobtrusive to other equipment stored on the trailer or storage unit.

### SUMMARY

Provided in this disclosure is an equipment rack for securing a piece of equipment to a vehicle. The equipment rack includes a base container having a base plate and a back plate attached perpendicularly to a first edge of the base plate. The equipment rests upon the base plate. One or more sidewalls are attached perpendicularly to one or more edges of the base plate, so that base plate and the sidewalls form a partial container enclosure to retain the equipment upon the base plate. An insert includes a rear support wall secured adjacently against the back plate of the base container. The insert is configured to selectively adjust the height of the insert above the base plate by displacing the rear support wall against the back plate.

A fold over latch is a component of the insert which is retained at a position on the rear support wall opposite from the base plate. The fold over latch is rotatable between a locked position and an unlocked position along a rotational axis parallel to the base plate. The fold over latch restrains the equipment when in the locked position. An extending arm extends outward from the base container. The extending arm includes a securing member which securely engages an extended component of the equipment.

The rear support wall of the insert includes a first set and a second set of vertically aligned openings respectively on a first side and an opposing second side of the rear support wall. The vertically aligned openings receive fasteners that engage circular openings on the back plate. In this manner, the vertically aligned openings are optionally selected to adjust the height of the insert above the base plate.

The insert includes a first hinge and a second hinge respectively comprising a first hinge plate and a second hinge plate which extend out from opposite sides of an inside surface of the rear support wall. The first and second hinge plates include respective first and second hinge plate openings for each receiving fasteners for pivotally connecting the fold over latch to the insert. The fold over latch includes a first parallel member and a second parallel member which are parallel to each other and a transverse member which transversely connects the first parallel member to the second parallel member. The first and second parallel members include respective first and second parallel member openings that cooperate with the first and second hinge plate openings to receive the respective fasteners. In this manner, these structures thereby define first and second hinges for pivotally connecting the fold over latch to the insert such that, the first parallel member, the second parallel member, the transverse member and the rear support wall form an aperture that fits over the equipment to restrain the equipment in place when in the locked position.

A locking opening is formed between either of the parallel members of the fold over latch and the rear support wall when aligned in the locked position, A locking mechanism (e.g., a padlock) is inserted into the locking opening to retain the fold over latch in the locked position to prevent the equipment from being removed from the equipment rack.

The extending arm is connected to the rear support wall of the insert. The extending arm includes a first end connected to the rear support wall and a second end extending outward from the rear support wall. The second end of the extending arm including the securing member comprising a curved portion for receiving the extended component. The extended component includes a hose of a blower and the curved portion is formed to receive the hose and hold the hose in an upright position to protect the hose from damage. The second end of the extending arm also includes a mounting structure to further secure the extending arm to a trailer of a vehicle. The curved portion also includes a band to secure the hose to the curved portion of the extending arm.

The equipment rack can also include one or more fasteners for engaging the equipment rack to a trailer of a vehicle. The equipment can include one or more of a backpack, a landscaping equipment, a blower, a backpack blower, or a container.

Other benefits and advantages of this invention will become apparent to those skilled in the art to which it pertains upon reading and understanding of the following detailed specification.

### III. BRIEF DESCRIPTION OF THE DRAWINGS

The accompanying drawings in the following description illustrate various exemplary implementations of the present disclosure. It is understood that a person of ordinary skill in the art may derive other implementations from these drawings which fall within the scope of the disclosure set forth herein.

FIG. 1 shows a left side perspective view of a lockable equipment rack attached to an open trailer in a closed configuration.

FIG. 2 shows a right side perspective view of a lockable equipment rack in a closed configuration.

FIG. 3 shows a back side of a lockable equipment rack.

FIG. 4 shows a left side perspective view of a lockable equipment rack in an open configuration.

FIG. 5 shows a lock engaging the rotatable member and securing it to the equipment rack.

FIG. 6 shows a left perspective view of a lockable equipment rack in an open configuration.

FIG. 7 shows a perspective backside view of a lockable equipment rack.

FIG. 8 shows an interior side view hinge securing a rotatable member or latch to an insert of a lockable equipment rack.

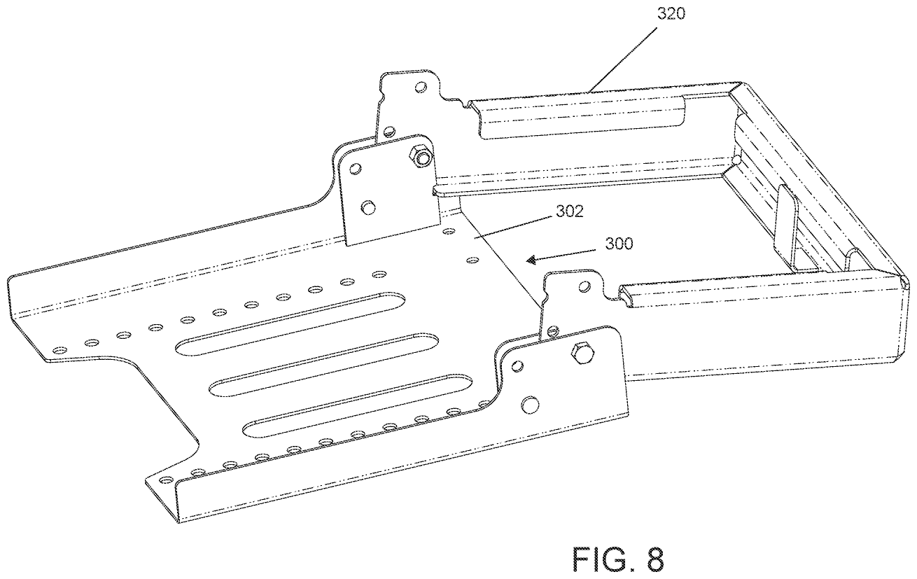

FIG. 9 shows the interior side of the second sidewall or backplate of a base container of a lockable equipment rack.

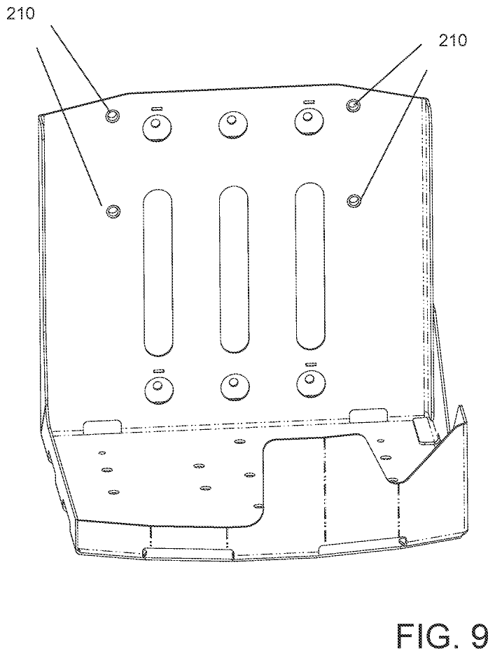

FIG. 10 shows a top view of a base container of a lockable equipment rack.

FIG. 11 shows a back view of a base container of a lockable equipment rack.

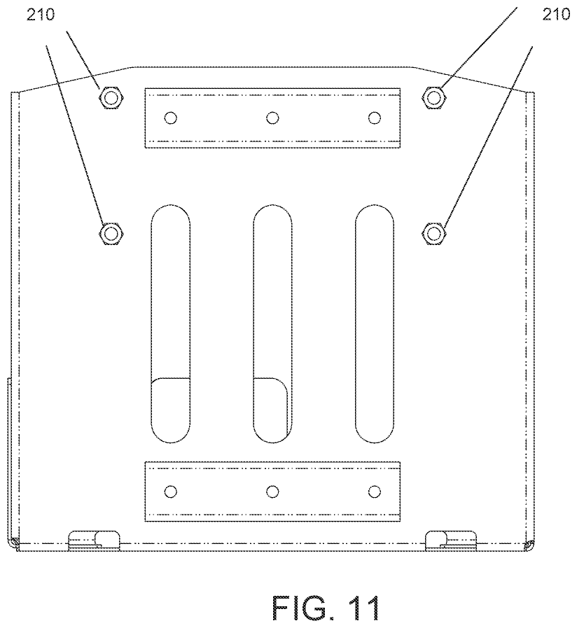

FIG. 12 shows a bottom view of a base container of a lockable equipment rack.

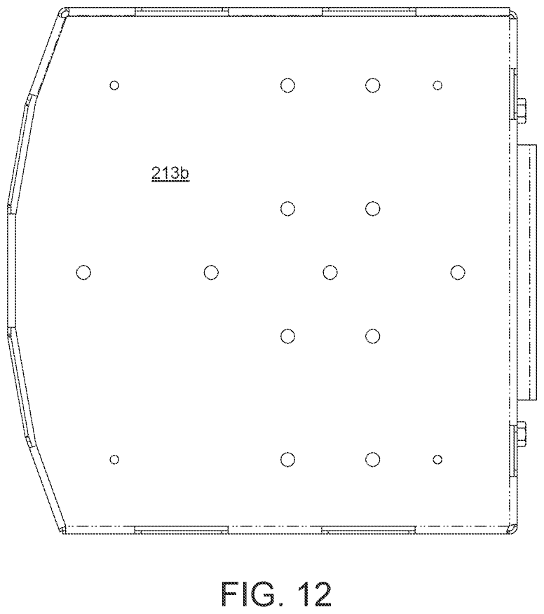

FIG. 13 shows a top view of an arm of a lockable equipment rack.

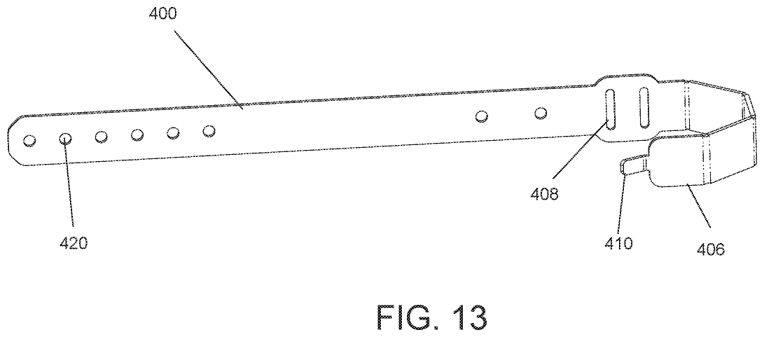

FIG. 14 is an exploded view showing the components of the equipment rack.

### IV. DETAILED DESCRIPTION

Referring now to the drawings wherein the showings are for purposes of illustrating embodiments of the article only and not for purposes of limiting the same, and wherein like reference numerals are understood to refer to like components:

The present disclosure is directed to a lockable equipment rack for storing various types of equipment on a trailer or storage unit. In particular, the lockable equipment rack is capable of storing a blower and other types of lawncare equipment on the frame of an open trailer. The lockable equipment rack provides a ready solution to problems associated with theft of blowers from the trailers of lawncare specialists and is useful for securing blowers in place within a lockable area to prevent such theft. One particular type of blower that the lockable equipment rack is useful with is backpack blowers.

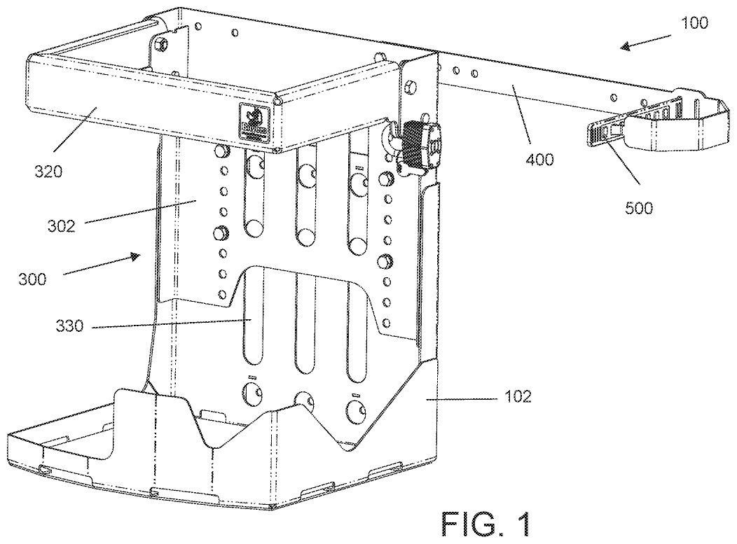

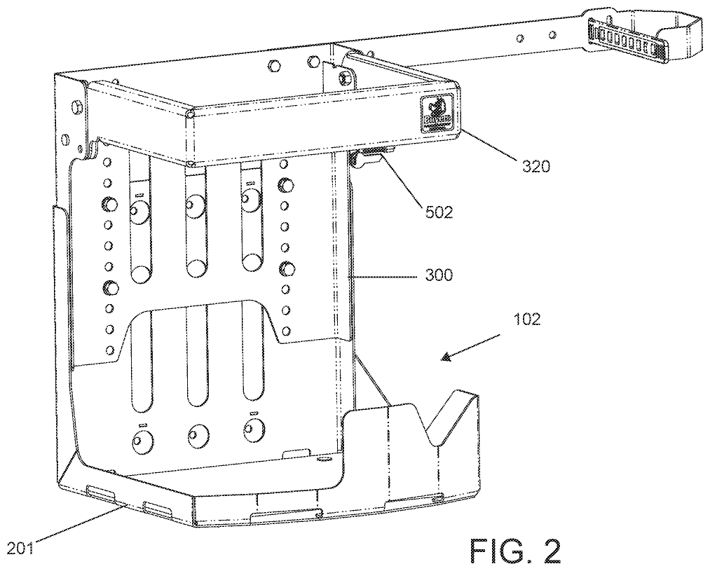

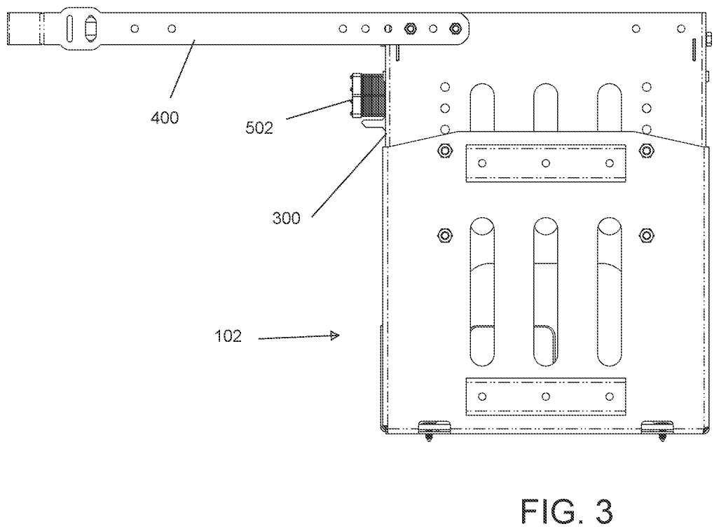

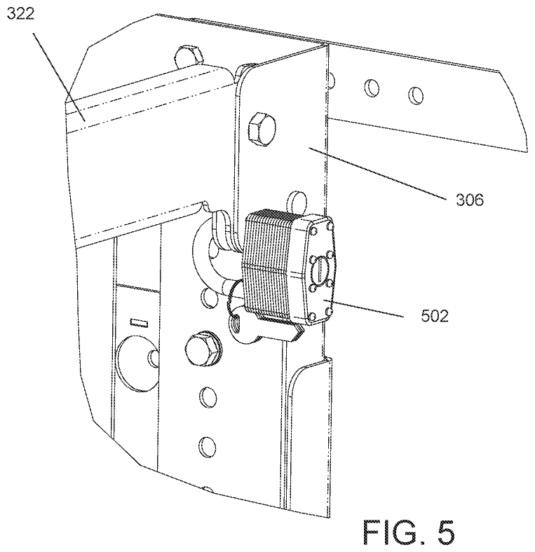

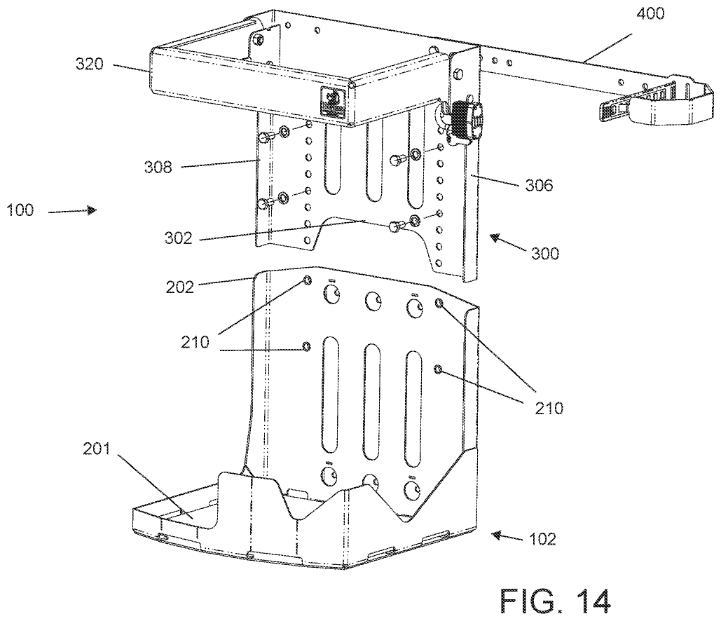

FIGS. 1 to 6 and 14 illustrate an equipment rack 100 including one or more of a base container 102, an insert 300 having a vertically oriented rear support wall 302 and a rotatable member 320 (also referred to as a fold over latch) that is rotatable along a horizontal axis, one or more locking mechanisms, an extending arm 400 that extends outward from one or more sides of the equipment rack 100, and a band 500 which engages the end of the arm, and/or other components

As suggested by the figures, a piece of equipment may be fastened, enclosed, restrained, and/or secured within the equipment rack 100. The equipment may sit in the base container. The equipment may also be described as resting on a rear support wall 302 of an insert 300 positioned within the base container 102 and abutting a second sidewall or back plate 202 of the base container 102. The rotatable member 320 of the insert 300 may restrain the equipment within the equipment rack 100 when in a locked position. A portion of the equipment may be positioned within an opening or space 328 formed between the rear support wall 302 and a front side of the rotatable member 320. The equipment may be one or more of a backpack, a landscaping equipment, a blower, a backpack blower, a container, and/or other equipment. The solid body of the base container 102 may form a shape, such as a rectangular shape, a triangular shape, a circular shape, and/or other shapes.

Referring FIGS. 1, 2, 4 and 6 in some implementations, the base container 102 may include one or more of a base plate 201 (e.g. bottom wall), a set of sidewalk, and/or other components. In some implementations, the base plate 201 may comprise a solid body having one or more surfaces and/or one or more edges. The solid body may form a shape, such as a rectangular shape, a triangular shape, a circular shape, and/or other shapes. In some implementations, the base plate includes a first interior surface 213a, a second bottom surface 213b opposite the first surface 213a, and/or other surfaces. In some implementations, the base plate 201 may further include a first front edge, a second back edge, a third left side edge and a fourth right side edge. In some implementations, the second back edge, third left side edge fourth right side edge of the base plate are linear or substantially linear while the first front edge is curved to accommodate the shape of the equipment. Each of the edges of the base plate 201 are attached to a corresponding sidewall as described below.

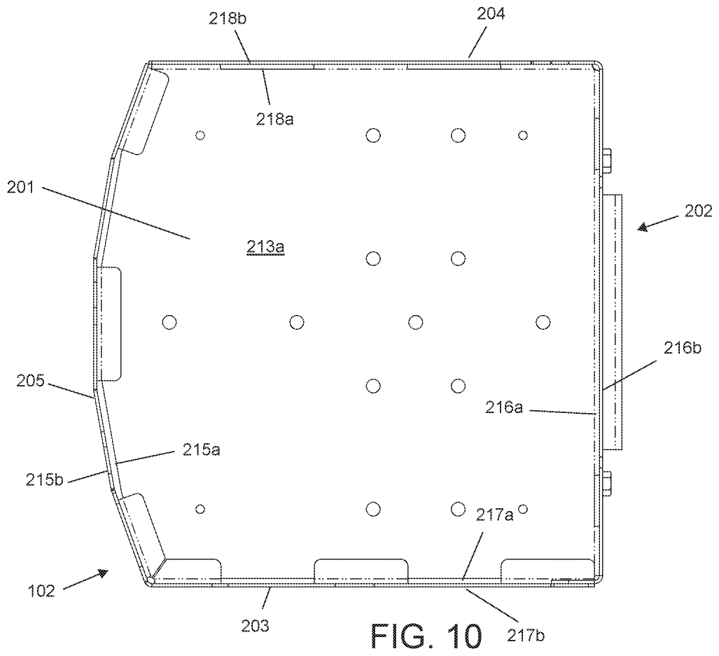

With reference to FIG. 10, the set of sidewalls attached to the base plate 201 may include one or more individual sidewalls. In some implementations, the set of sidewalls include a first sidewall 205 attached to a first front edge of the base plate 201, a second sidewall 202 attached to a second back edge of the base plate, a third sidewall 203 attached to a third left side edge of the base plate and, a fourth sidewall 204 attached to a fourth right side edge of the base plate. It is to be understood however that other sidewalls configurations are also contemplated in other implementations. The base container 102 and the sidewalls described above may form a partial container enclosure. In some implementations, the first sidewall 205, second sidewall 202, third sidewall 203 and fourth sidewall do not extend upward directly from the corresponding first edge, second edge, third edge and fourth edge of the base plate 201. Instead, these sidewalls extend outward from the corresponding edges of the base plate 201 before extending upward. In other implementations, the sidewalls may be described as not being attached directly to the corresponding edges of the base plate 201. The configuration described in either of these implementations provides for a gap between the sidewalk and the corresponding edges of the base plate 201. This gap allows for at least one opening between one or more of the sidewalk 205, 202, 203, 204 and the base plate 201. In the implementations shown in FIGS. 1, 2, 4, and 6, the two openings are formed by the gap between each of the first sidewall 205 and the first edge of the base plate, the second sidewall 202 and the second edge of the base plate, the third sidewall 203 and the third edge of the base plate and the fourth sidewall 204 and the fourth edge of the base plate. These openings allow for drainage of liquid such as water, gas oil, etc. from the base plate 201 of the base container 102.

The partial enclosure formed by the base container 102 may be configured to partially enclose the equipment. The set of sidewalls may traverse base plate 201 along the base plates 201's perimeter. The base plate 201 and/or set of sidewalls may be joined together to form the partial enclosure. The partial enclosure may be formed such that rotation of the equipment relative the base container 102 and/or other components may be 20 restricted with respect to one or more axes of rotation. In a non-limiting example, the base container 102 may prevent the equipment from rotating in a longitudinal axis, a latitudinal axis, and/or other axis when the equipment is within the base container 102. The base container 102 may prevent the equipment from rotating in any axis of rotation.

In some implementations, the base plate 201 may be configured to prevent access to one or more sides of the equipment 110. The base plate 201 may enclose one or more sides of the equipment. The base plate 201 may be made of one or more materials. In a non-limiting example, the one or more materials may include one or more of metal, wood, plastic, carbon fiber, and/or other materials.

In some implementations, the solid body of the base plate 201 may include at least one or a plurality of openings. The openings may be of different sizes and shapes or may be the same size and shape. The individual openings are designed to communicate through the solid body of the base plate 201 from the first surface 213a to the second opposing surface 213b. The individual openings are located within the boundaries and/or perimeter of the base plate 201. According to certain aspects of the present teaching, the individual openings in the base plate may be circular in shape. The circular shape of the openings may, in certain implementations, may be designed to receive a fastener such as a bolt for engaging the lockable equipment rack 100 to a separate surface with a corresponding nut. For example, the opening within the base plate 201 may receive a bolt which extends into an opening on a rail of a trailer or storage container and a nut may then be screwed onto the opposing end of the bolt to engage and secure the lockable equipment rack to the rail of the trailer. Thus, one or more of a plurality of openings may be used to couple the base plate 201 to one or more support surfaces and/or objects and/or provide other purposes.

In some implementations, the base plate 201 may include a set of openings configured to receive one or more of one or more fasteners, and/or other coupling devices. In sonic implementations, the individual openings in the set of openings may be configured to facilitate one or more of a coupling between base plate 201 and/or one or more surfaces, components, equipment, and/or other objects. In some implementations, the individual openings in the base plate may be configured to reduce the weight of the base plate 201 and/or provide other purposes. For example, one or more of a plurality openings within the base plate 201 may also be used to facilitate air ventilation for heat dissipation, drainage, weight reduction and heat dissipation.

In some implementations, some of the individual openings in the base plate may be aligned on the base plate 201 in one or more patterns. In a non-limiting example, some of the individual openings in the base plate may be aligned in one or more of a linear pattern, circular pattern, angular pattern, rectangular pattern, and/or other patterns or a combination thereof. Some of the individual openings in the first set of openings may be aligned along the edges and/or close to the edges the surfaces of the base plate 201. The openings in the base plate 201 may also be of different sizes or of the same size.

In some implementations, the base plate 201 may be configured to couple to one or more support surfaces and/or other objects for mounting and/or securing the base plate 201 and/or the equipment rack 100. In a non-limiting example, the base plate 201 may be configured to couple to one or more of a floor, a truck bed, a rail, a pole and/or other surfaces, objects, and/or components.

In some implementations, the base plate 201 may be sized to support and/or enclose the equipment. In a non-limiting example, the base plate 201 may be defined by one or more of a first length L1, a first width W1, a first thickness T1, and/or other measurements. In some implementations, the first length L1 may be in the range 0 to 1 meters. In some implementations, the first length L1 may be in the range 0 to 0.75 meters. In some implementations, the first length L1 may be in the range 0 to 0.5 meters. In some implementations, the first length L1 may be in the range 0 to 0.25 meters. In some implementations, the first length L1 may be in the range 0.25 to 0.4 meters. In some implementations, the first length L1 may be in the range 0.4 to 0.5 meters. In some implementations, the first width W1 may be in the range 0 to 1 meters. In some implementations, the first width W1 may be in the range 0 to 0.75 meters. In some implementations, the first width W1 may be in the range 0 5 to 0.5 meters. In some implementations, the first width W1 may be in the range 0 to 0.25 meters. In some implementations, the first width W1 may be in the range 0.25 to 0.4 meters. In some implementations, the first width W1 may be in the range 0.4 to 0.5 meters. In some implementations, the first thickness T1 may be in the range 0 to 0.1 meters. In some implementations, the first thickness T1 may be in the range 0 to 100.075 meters. In some implementations, the first thickness T1 may be in the range 0 to 0.05 meters. In some implementations, the first thickness T1 may be in the range 0 to 0.01 meters. In some implementations, the first thickness T1 may be in the range 0 to 0.005 meters. In some implementations, the first thickness T1 may be in the range 0 to 0.001 meters. In some implementations, the first thickness T1 may be in the range 150.001 to 0.005 meters. In some implementations, the first thickness T1 may be in the range 0.005 to 0.01 meters.

Referring to the base container 102 in FIGS. 1, 2, 4 and 6, in some implementations, the set of sidewalk of the base container 102 may include one or more of a first sidewall 205, a second sidewall 202, a third sidewall 203, a fourth sidewall 204, and/or other sidewalk. In some implementations, the first sidewall 205, the second sidewall 202, the third sidewall 203, and/or the fourth sidewall 204 may be configured to prevent access to one or more sides of the equipment. The first sidewall 205, the second sidewall 202, the third sidewall 203, and/or the fourth sidewall 204 may enclose one or more sides of the equipment. The first sidewall 205, the second sidewall 202, the third sidewall 203, and/or the fourth sidewall 204 may be made of one or more materials. In a non-limiting example, the one or more materials may include one or more of metal, plastic, wood, carbon fiber, and/or materials.

In some implementations, the individual sidewalls in the first of sidewalls (such as the first sidewall 205, the second sidewall 202, the third sidewall 203, the fourth sidewall 204 and/or other sidewalls) may include individual solid bodies having one or more surfaces and/or one or more edges. The one or more surfaces may include a first side interior surface 215a, a first side exterior surface 215b opposite 215a, a second side interior surface 216a, a second side exterior surface opposite 216a, a third side interior surface 217a, a third side exterior surface 217b opposite 217a, a fourth side interior surface 218a, a fourth side exterior surface 218b opposite 218a.

In some implementations, the first sidewall 205 may be sized to support and/or enclose the equipment. In a non-limiting example, the first sidewall 205 may include two portions defined by different heights with respect to the base plate 201. For example, the first sidewall 205 may include a first portion which extends at a height (H1) from the base plate 201 along a length (L1) of the first sidewall (205) and a second portion which extends at a height (H2) from the base plate 201 along a length (L2) of the first sidewall. In some implementations, the height of the second portion (H2) is greater than the height of the first portion (H1) of the first sidewall 205. In some implementations, the length of the first portion is approximately equal to the length of the second portion of first sidewall 205, although it is also contemplated that the length of the second portion may be greater than that of the first portion of the first sidewall or that the length of the first portion may be greater than that of the second portion of the first sidewall 205. In some implementations, where the second portion of the first sidewall 205 has a height that is greater than that of the first portion of the first sidewall 205, the second portion of the first sidewall 205 may include a V-shaped cutaway. The V-shaped cutaway may serve several purposes including but not limited to providing access to the equipment stored within the lockable equipment rack or weight reduction and preventing the equipment from being removed from the lockable equipment rack when locked. In some implementations, the V-shaped cutaway has a first side which extends downward to an endpoint within the second portion of the first sidewall 205 and a second side which extends upward. In some implementations, the end point of the V-shaped cutaway is curved. In some implementations, the second side of the V-shaped cutaway extends upward to a corner point where the first sidewall 205 meets the adjacent sidewall (e.g., the third sidewall 203). In some implementations, the first and second portions of the first sidewall 205 may or may not have one or more degrees of curvature and or an angled portions coinciding with shape of the base plate 201 to provide extra space and allow for fitting equipment within the lockable equipment rack. In some implementations, the first sidewall 205 has a top edge which may or may not have one or more degrees of curvature or angled portions to accommodate the shape of the equipment stored within the lockable equipment rack.

The second sidewall 202, also referred to as the back plate 202 extends upward from the base plate 201 at a height that is greater than that of the first sidewall 205, the third side wall 203 and the fourth sidewall 204. In some implementations, the height of the second sidewall is designed to accommodate a substantial portion of the equipment stored within the lockable equipment rack. In some implementations, the back plate 202 includes one or more openings within the center portion of the back plate 202. For example, in some implementations, the back plate 202 may include three substantially linear oval shaped openings vertically oriented within the center portion of the back plate. The back plate 202 may further include three circular shaped openings below the vertically oriented linear oval shaped openings and three circular shaped openings above the vertically oriented linear shaped openings on the interior side of the back plate 202. These openings may serve several purposes including but not limited to providing a means for equipment to cool down after use when stored within the rack by allowing the passage of air through the support rack to the equipment, a means for keeping the support rack cool when storing hot equipment, a means for providing weight reduction for the support rack and a means to providing access to mounting holes on the exterior surface of the back plate 202 as described in greater detail below.

As shown in FIG. 10, in some implementations, the back plate 202 may include four circular openings 210 surrounding the center portion of back plate through which a fastener such as a bolt (or any other suitable type of fastener) may pass through. In some implementations, these openings on the back plate 202 may be surrounded by a welded nut on the exterior surface of the back plate. The use of these openings is discussed in greater detail below.

In some implementations, the back plate 202 may further include one, two or more mounting brackets. The mounting brackets may be positioned above and/or below the vertically oriented substantially linear oval shaped openings within the back plate. In some implementations, the mounting brackets are horizontally oriented and/or are welded onto the back plate 202. In some implementations, the mounting brackets may be standoffs from the exterior or outer surface of the back plate 202. These standoffs may form a channel with respect to the back plate 202 and allow for mounting the equipment rack against a wall. The channel may be any shape depending on the configuration of the mounting bracket. In some implementations, the channel formed by the insert and the back plate 202 is in the shape of a rectangular prism. This channel may provide a means for storing an extending arm 400 (discussed in greater detail below) or other accessory to the lockable equipment rack. In some implementations, the mounting brackets may have one or more openings which are accessible from the exterior surface of the back plate 202. The interior surface of the back plate 202 may include one or more corresponding openings in line with the openings within the mounting bracket. The openings within the interior surface of the back plate 202 may have a diameter which is larger than the diameter of the openings on the mounting brackets. This configuration allows one to fit one's fingers or hand within the larger diameter opening within the interior side of the back plate 202 to insert a fastener (for example, a bolt or any other suitable type of fastener) from the interior side of the back plate 202, through the inline opening within the mounting insert to a corresponding opening on a mountable surface to engage the lockable equipment rack to a surface.

In some implementations, the second sidewall or back plate 202 may or may not have one or more degrees of curvature and or angled portions coinciding with shape of the base plate 201 to provide extra space and allow for fitting equipment within the lockable equipment rack. In some implementations, the second sidewall or back plate 202 has a top edge which may or may not have one or more degrees of curvature or angled portions to accommodate the shape of the equipment stored within the lockable equipment rack.

In some implementations, the third sidewall 203 may be sized to support and/or enclose the equipment. In a non-limiting example, the third sidewall 203 may include a first portion having a V-shaped cutaway. The V-shaped cutaway may serve several purposes including but not limited to providing access to the equipment stored within the lockable equipment rack or weight reduction and preventing the equipment from being removed from the lockable equipment rack when locked. In some implementations the V-shaped cutaway has a first side which extends downward to an endpoint towards the center portion of the third sidewall 203 and a second side which extends upward towards a second portion of the third sidewall 203. In some implementations, the second side of the V-shaped cutaway extends upward to meet a second portion of the third sidewall 203 adjacent the second sidewall or back plate 202. The second portion of the third sidewall 203 may have a height (H2) which is greater than the height (H1) of the first portion of the third sidewall having the V-shaped cutaway. In some implementations, the height of the second portion of the third sidewall is equivalent to or substantially equivalent to the height of the second sidewall or back plate 202. In other implementations, the third sidewall 203 does not have a second portion and instead, the second side of the V-shaped cutaway extends upward to a corner point where the third sidewall 203 meets the adjacent sidewall (e.g., the second sidewall or back plate 202). In some implementations, the third sidewall 203 may or may not have one or more degrees of curvature and or angled portions coinciding with shape of the base plate 201 to provide extra space and allow for fitting equipment within the lockable equipment rack. In some implementations, the third sidewall 203 has a top edge which may or may not have one or more degrees of curvature or angled portions to accommodate the shape of the equipment stored within the lockable equipment rack.

In some implementations, the fourth sidewall 204 may be sized to support and/or enclose the equipment. In a non-limiting example, the fourth sidewall 204 may include two portions defined by different heights with respect to the base plate 201. For example, the fourth sidewall 204 may include a first portion which extends at a height (H1) from the base plate 201 along a length (L1) of the fourth sidewall 204 and a second portion which extends at a height (H2) from the base plate 201 along a length (L2) of the fourth sidewall 204. In some implementations, the height of the second portion (H2) is greater than the height of the first portion (H1) of the first sidewall 205. In some implementations, the length of the first portion is greater than the length of the second portion of fourth sidewall 205. In some implementations, the height of the second portion of the fourth sidewall is contemplated to be equivalent to or substantially equivalent to the height of the second sidewall or back plate 202. It is to be understood that it is also contemplated that the length of the second portion of the fourth sidewall may be greater than that of the first portion of the fourth sidewall 204 or that the length of the first portion may be greater than that of the second portion of the fourth sidewall 204. It is also contemplated that in other implementations, the fourth sidewall 204 may not have a second portion and instead, the fourth sidewall extends along its length at a uniform height towards a corner point where the fourth sidewall 204 meets the adjacent sidewall (e.g., the second sidewall or back plate 202). In some implementations, the fourth sidewall 204 may or may not have one or more degrees of curvature and or angled portions coinciding with shape 15 of the base plate 201 to provide extra space and allow for fitting equipment within the lockable equipment rack. In some implementations, the fourth sidewall 203 has a top edge which may or may not have one or more degrees of curvature or angled portions to accommodate the shape of the equipment stored within the lockable equipment rack.

As described above, the first sidewall 205, the second sidewall 202, the third sidewall 203 and the fourth side wall 204 are attached to corresponding side of the base plate 201. In some implementations, it is also contemplated that each of the sidewalls, 205, 202, 203 and 204 may or may not include at least one opening or slot at a point where the sidewall meets the base plate. This is shown in FIGS. 1-4 and 6 which illustrate each of the first sidewall, second sidewall, third sidewall and fourth sidewall having two slots or openings at points where the sidewall meets the base plate. These openings or slots provide a means to discharge liquid such as water, a means to dissipate heat from hot equipment stored within the lockable equipment rack, a means to keep the lockable equipment rack cool, a means to reduce the weight of the lockable equipment rack and a means to grip the lockable equipment rack with ones fingers and hands for purposes of lifting and carrying the rack.

As mentioned above, the equipment rack 100 includes an insert 300 having a vertically oriented rear support wall 302 and a rotatable member 320 that is rotatable along a horizontal axis. The insert 300, including the vertically oriented rear support wall 302, is designed to fit within the interior of the equipment rack 100. This is accomplished by inserting the insert within an opening at the top of the base container 102 of the equipment rack 100 and positioning the rear support wall 302 of the insert 300 adjacent to the second sidewall or back plate 202 of the base container 102 of the equipment rack 100. The rear support wall 302 of the insert 300 includes a first set and a second set of vertically aligned openings on a first side and an opposing second side of the rear support wall 302 wherein the first side and second side of the rear support wall 302 are on opposite sides of a longitudinal axis that crosses through the center of the rear support wall 302. The first set and second set of vertically aligned openings on the first side and second side of the rear support wall are spaced a distance from a center longitudinal axis of the rear support wall 302. These openings allow for one or more fasteners (including but not limited to a bolt or any other suitable type of fastener) to be inserted into the vertically aligned openings and pass through to engage one of four circular openings 210 and corresponding welded nut surrounding the center portion on the back side of the back plate 202. As two fasteners are passed through the first set of vertically aligned openings of the rear support wall 302 and two fasteners are passed through the second set of vertically aligned openings on the rear support wall 302 to engage each of the four openings 210 and welded nuts on the back plate 202, the rear support wall 302 of the insert 300 can engage the back plate 202 of the equipment rack 100. The series of vertically aligned openings on the first side and second side of the rear support wall provide a user with options for selecting which openings within the rear support wall to elect to fasten with respect to back plate 202 which allows the height of the insert 300 to be easily adjusted with respect to the container portion of the equipment rack 100.

In some implementations the center portion of the rear support wall 302 includes at least one vertically oriented opening which allows for an overlap of a corresponding opening within the center portion of the back plate 202. In some implementations, the rear support wall 302 includes three vertically oriented substantially linear oval shaped openings within the center portion which are designed to overlap the three vertically oriented substantially linear oval shaped openings within the center portion of the back plate 202. These openings allow for hot equipment stored within the equipment rack to cool down, for the support rack holding hot equipment to cool, and for weight reduction of the equipment rack 100.

In some implementations, the insert 300 includes a first sidewall 306 and a second side wall 308 which extend out from a first edge and a second edge of the rear support wall 302. The first side wall 306 and second side wall 308 of the insert 300 may have a first portion having a first height (H1) from the rear support wall 302 which extends along a first length (L1) and a second portion having a second height (H2) from the rear support wall which extends along a second length (L2). In some implementations, the first portion of the first sidewall 306 and the first portion of the second sidewall 308 allows for the insert to be secured. within the equipment rack, for the insert 300 to slide within the container portion of the equipment rack allowing for adjustment of the insert 300 to various heights with respect to the container portion of the equipment rack and provides a further means for securing the equipment within the container portion of the equipment rack.

In some implementations, the first portion of the first sidewall 306 engages the second portion of the third sidewall 203 of the base container 102 and the first portion of the second sidewall 1308 engages the second portion of the fourth sidewall 204 of the base container 102 as the insert 300 is inserted within and engages the base container 102. Thus, the second portion of 25 the third sidewall 203 and the second portion of the fourth sidewall 204 functions as a guide directing the passage of the insert 300 within the base container 102. This guide provides structural integrity to the equipment rack in that it functions to hold the insert 300 in place within the base container 102 and in that it prevents the insert 300 from moving or falling out of place within the base container 102 which would otherwise interfere with the storage of the equipment within the base container 102.

In some implementations, the insert 300 includes a cutout 330 on the bottom portion of the insert 300. This cutout 330 provides space allowing the insert to accommodate the shape and configuration of the equipment (e.g. a blower) that is stored within the base container. The cutout 330 thus prevents the insert from interfering with the storage of equipment within the base container 102.

In some implementations, the insert 300 also includes two hinges. A first hinge may be formed by the second portion of the first sidewall 306 which forms a first hinge plate and a corresponding second hinge plate which extends out from the inside surface of the rear support wall 302 and which is adjacent to the first hinge plate within the interior side of the bracket. A second hinge may be formed by the second portion of the second sidewall 308 which forms a second hinge plate and a corresponding second hinge plate which extends out from the inside surface of the rear support wall 302 and positioned adjacent to the first hinge plate within the interior side of the bracket.

In some implementations, the first hinge plate formed by the second portion of the first sidewall 306 and the first hinge plate formed by the second portion of the second sidewall 308 includes a first opening 310 and a second opening 312. Also, the second hinge plate positioned adjacent to the first sidewall 306 and the second hinge plate positioned adjacent to the second sidewall 312 also includes a corresponding first opening (not shown) and a second opening (not shown) respectively aligned with the first opening 310 and second opening of the first hinge plate of the second portion of the first sidewall 306 and the second portion of the second sidewall 308. The first opening 310 of the second portion of the first sidewall 306 and the second sidewall 308 allows for passage of a fastener (e.g., a bolt and nut combination or any other type of fastener) to secure the insert to a rotatable member 320. This fastener passes through a corresponding first opening (not shown) on a first and second side of the rotatable member and the corresponding first opening (not shown) on the second hinge plate positioned adjacent to the first sidewall 306 and likewise the second hinge plate positioned adjacent to the second sidewall 312. In some implementations, where a bolt is used as a fastener, a nut may be used to engage the bolt on an interior surface of the corresponding second hinge plates. Thus, a hinge is provided allows the rotatable member to rotate from an upward position to a downward position over equipment that is stored within the container portion of the equipment rack and from a downward position to an upward position allowing for removal of the equipment from the container portion of the equipment rack. The rotatable member may be of any shape and may be a single piece or several pieces connected together.

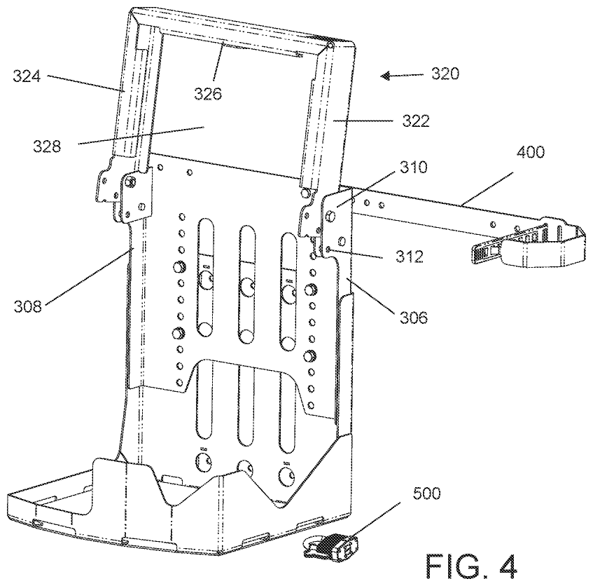

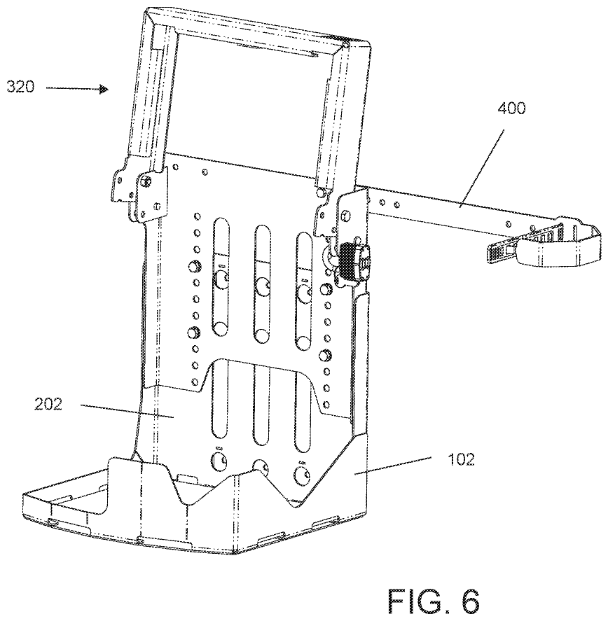

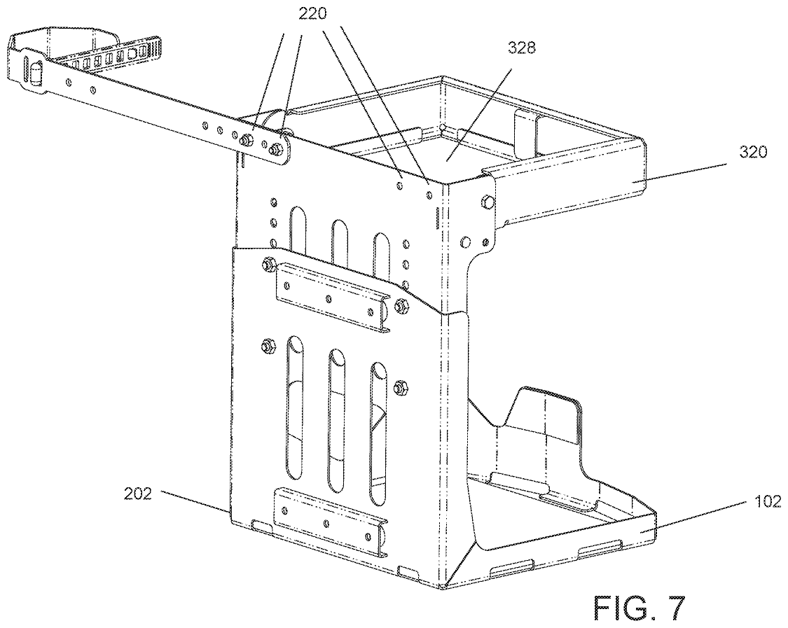

As shown in FIG. 4, in some implementations, the rotatable member 320 includes a first member 322 and a second member 324 which are parallel to each other and a third member 326 which connects the first member 322 to the second member. The first member 322, second member 324, third member 326 and the rear support wall 302 form an opening 328 that fits over the equipment to secure it in place. The rotatable member 320 also includes a first end portion and a second end portion. In some implementations, the first end plate is positioned at the first end portion of the rotatable member and a second end plate is positioned at the second end portion of the rotatable member. In some implementations the first end plate may be described as being positioned on an end portion of the first member and the second end plate may be describe as being positioned on an end portion of the second member 324 of the rotatable member 320. The first end plate of the first member 322 is positioned in between the first hinge plate of the first sidewall 306 and the corresponding second hinge plate adjacent to the first hinge plate. Likewise, the first end plate of the second member 324 is positioned in between the first hinge plate of the second sidewall 308 and the corresponding second hinge plate adjacent to the first hinge plate. This configuration allows for a hinge to be formed between the rotatable member 320 and the insert 300. In some implementations, the hinge may also be provided with a locking mechanism 502 as described in detail below. When the insert 300 is locked when the rotatable member 320 is pivoted downward into the locking position, as shown in FIGS. 1, 2, 3, and 7, the equipment is locked within the opening 328 formed by the rotatable member and the rear support wall 302 and the equipment is prevented from being removed from the equipment rack 100. The equipment can be released when the insert 300 is unlocked when the rotatable member 320 is pivoted upward into the unlocked position as shown in FIGS. 4 and 6.

As mentioned above, the second portion of the first sidewall 306 (i.e., the first hinge plate) and the second portion of the second sidewall 308 (i.e., the second hinge plate) of the insert 300 includes a second opening 312. Likewise, the first side of the rotatable member, for example, the first member 322 and the second side of the rotatable member, for example, the second member 324 includes a corresponding second opening (not shown) respectively in-line with the second opening 312 of the first sidewall 306 and the second opening 312 of the second sidewall 308. Likewise, each of the second hinge plates include a corresponding second opening in-line with the second opening 312 of the first and second hinge plates and respectively in-line with the second opening of the first member 322 and the second opening of the second member 324 of the insert 300. These openings allow for insertion of a locking mechanism 502 (for example, a padlock, combination lock, key lock, or any other type of lock) into one or more of the second opening of the second hinge plates, the second opening of either the first member 322 and/or the second member 324 of the insert 300 and one or both of the second opening of the second hinge plates to prevent rotation of the rotatable member 320 and lock the equipment within the container portion of the equipment rack.

As mentioned above, in some implementations, the equipment rack 100 also includes an extending arm 400 that extends outward from one or more sides of the equipment rack 100. In some implementations, the extending arm 400 is connected to the rear support wall 302 of the insert 300. To achieve this connection, the rear support wall 302 of the insert 300 may include one or more openings 220 aligned in a horizontal manner. In some implementations, these openings may be positioned along an upper half or towards the top of the rear support wall 302. The arm extending 400 may also include one or more similarly sized corresponding openings 420. To connect the arm extending 400 to the rear support wall 302, the arm openings 420 may be aligned with the rear support wall openings 220 and a fastener may be inserted through one or more of the aligned openings 220 and 320. An example of a fastener that may be used is a nut and a bolt although any other type of suitable fastener may also be use used. In some implementations, it is desirable to secure the extending arm 400 to the rear support wall 302 with two or more fasteners.

In some implementations, the arm may further be described as having a first end 402 which is connected to the rear support wall 302 and a second end 402 which extends outward from the rear support wall 302. The second end 402 of the extending arm 400 may include a curved portion 406 for receiving a component of a piece of equipment that is stored within the container portion of the equipment rack. The curved portion 406 may be formed by a continuous curve or by angling several sections of the second end 402 of the arm to form a curve. As suggested in FIG. 6, the curved portion 406 can receive a hose of a blower and holds the hose in an upright position. This is accomplished by attaching the arm to the upper half or towards the top of the rear support wall 302 and provides an advantage in terms of proper storage for beneficial use of the equipment and in terms of keeping the hose away from the road and components of the trailer (e.g., the rail) which could potentially cause damage to the hose during travel. The second end of the extending arm 400 may include one or more openings before the curved portion 406 to further secure the arm to a rail or other mounting surface with a fastener such as a bolt and nut combination or any other suitable type of fasteners. The second end 402 of the extending arm 400 may also include one or more slots 408 positioned before the curved portion 406. The second end of the arm 402 may include a tab 410 after the curved portion. A band 500 may engage one or more of the slots 408 and the tab 410 to secure the hose or external equipment component to the curved portion 406 of the extending arm 400. The band may be in any form, shape or configuration capable of attaching to one or more of the slots 408 and the tab 410. In some implementations, the band 500 may be made of a rigid material (e.g., a metal) or a flexible material (e.g., a string, rope or rope-like material). In some implementations, the band made of a rigid material and includes at least one slot for engaging tab 410 and a tab at one of its ends for engaging one of slots 408.

While the lockable equipment rack provided herein has been described in connection with various illustrative implementations, it is to be understood that other similar implementations may be used or modifications and additions may be made to the described implementations for performing the same function disclosed herein without deviating therefrom. Further, all implementations disclosed are not necessarily in the alternative, as various implementations may be combined or subtracted to provide the desired characteristics. Variations can be made by one having ordinary skill in the art without departing from the spirit and scope hereof. Therefore, the lockable equipment rack should not be limited to any single embodiment, but rather construed in breadth and scope in accordance with the recitations of the appended claims.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. An equipment rack for securing an equipment to a vehicle, comprising:
a base container including a base plate and a back plate attached perpendicularly to a first edge of the base plate, wherein the equipment rests upon the base plate;
at least one sidewall attached perpendicularly to at least a second edge of the base plate, wherein the base plate and the at least one sidewall form at least a partial container enclosure to retain the equipment upon the base plate;
an insert comprising a rear support wall secured adjacently against the back plate of the base container, wherein the insert is configured to selectively adjust a height of the insert above the base plate by displacing the rear support wall against the back plate;
a fold over latch of the insert retained at a position on the rear support wall opposite from the base plate, the fold over latch being rotatable between a locked position and an unlocked position along a rotational axis parallel to the base plate, wherein the fold over latch restrains the equipment when in the locked position; and
an extending arm that extends outward from the base container, the extending arm comprising a securing member which securely engages an extended component of the equipment.

2. The equipment rack of claim 1, further comprising at least one fastener for engaging the equipment rack to a trailer of a vehicle.

3. The equipment rack of claim 1, wherein the rear support wall of the insert includes a first set and a second set of vertically aligned openings respectively on a first side and an opposing second side of the rear support wall, the vertically aligned openings receive fasteners that engage circular openings on the back plate, such that the vertically aligned openings are optionally selected to adjust the height of the insert above the base plate.

4. The equipment rack of claim 1, wherein the insert includes a first hinge and a second hinge respectively comprising a first hinge plate and a second hinge plate which extend out from opposite sides of an inside surface of the rear support wall, wherein the first and second hinge plates include respective first and second hinge plate openings for each receiving fasteners for pivotally connecting the fold over latch to the insert.

5. The equipment rack of claim 4, wherein the fold over latch comprises a first parallel member and a second parallel member which are parallel to each other and a transverse member which transversely connects the first parallel member to the second parallel member, wherein the first and second parallel members include respective first and second parallel member openings that cooperate with the first and second hinge plate openings to receive the respective fasteners, thereby defining first and second hinges for pivotally connecting the fold over latch to the insert such that the first parallel member, the second parallel member, the transverse member and the rear support wall form an aperture that fits over the equipment to restrain the equipment in place when in the locked position.

6. The equipment rack of claim 5, further comprising a locking opening formed between one of the parallel members of the fold over latch and the rear support wall when aligned in the locked position, wherein a locking mechanism is inserted into the locking opening to retain the fold over latch in the locked position to prevent the equipment from being removed from the equipment rack,

7. The equipment rack of claim 1, wherein the equipment is at least one of a backpack, a landscaping equipment, a blower, a backpack blower, or a container.

8. The equipment rack of claim 1, wherein the extending arm is connected to the rear support wall of the insert.

9. The equipment rack of claim 1, wherein the extending arm comprises a first end connected to the rear support wall and a second end extending outward from the rear support wall, wherein the second end of the extending arm including the securing member comprising a curved portion for receiving the extended component.

10. The equipment rack of claim 9, wherein the extended component of the equipment comprises a hose of a blower and wherein the curved portion is formed to receive the hose and hold the hose in an upright position to protect the hose from damage.

11. The equipment rack of claim 10, wherein the second end of the extending arm further comprises a mounting structure to further secure the extending arm to a trailer of a vehicle.

12. The equipment rack of claim 10, wherein the curved portion further comprises a band to secure the hose to the curved portion of the extending arm.

13. An equipment rack for securing an equipment to a vehicle, comprising:
a base container including a base plate and a back plate attached perpendicularly to a first edge of the base plate, wherein the equipment rests upon the base plate;
at least one sidewall attached perpendicularly to at least a second edge of the base plate, wherein the base plate and the at least one sidewall form at least a partial container enclosure to retain the equipment upon the base plate;
an insert comprising a rear support wall secured adjacently against the back plate of the base container, wherein the insert is configured to selectively adjust a height of the insert above the base plate by displacing the rear support wall against the back plate;
a fold over latch of the insert retained at a position on the rear support wall opposite from the base plate, the fold over latch being rotatable between a locked position and an unlocked position along a rotational axis parallel to the base plate, wherein the fold over latch restrains the equipment when in the locked position, wherein the fold over latch further comprises a first parallel member and a second parallel member which are parallel to each other and a transverse member which transversely connects the first parallel member to the second parallel member, wherein the first parallel member, the second parallel member, the transverse member and the rear support wall form an aperture that fits over the equipment to secure it in place when in the locked position; and
an extending arm that extends outward from the base container, the extending arm comprising a securing member which securely engages an extended component of the equipment.

14. An equipment rack for securing a blower to a vehicle, comprising:
a base container including a base plate and a back plate attached perpendicularly to a first edge of the base plate, wherein the blower rests upon the base plate;
at least one sidewall attached perpendicularly to at least a second edge of the base plate, wherein the base plate and the at least one sidewall form at least a partial container enclosure to retain the blower upon the base plate;
an insert comprising a rear support wall secured adjacently against the back plate of the base container, wherein the insert is configured to selectively adjust a height of the insert above the base plate by displacing the rear support wall against the back plate;
a fold over latch of the insert retained at a position on the rear support wall opposite from the base plate, the fold over latch being rotatable between a locked position and an unlocked position along a rotational axis parallel to the base plate, wherein the fold over latch restrains the blower when in the locked position; and
an extending arm comprising a first end connected to the rear support wall and a second end extending outward from the rear support wall, wherein the second end of the extending arm including a curved portion for receiving a hose of the blower and hold the hose in an upright position to protect the hose from damage, wherein the curved portion further comprises a band to secure the hose to the curved portion.
